(19) United States
(12) Patent Application Publication
(10) Pub. No.: US 2006/0221309 A1
(43) Pub. Date: Oct. 5, 2006

(54) Projection type of image displaying apparatus

(75) Inventors: Satoshi Onishi, Amagasaki-shi (JP); Shinichi Suzuki, Osaka (JP); Atsushi Matsuura, Osaka (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 11/392,178

(22) Filed: Mar. 29, 2006

(30) Foreign Application Priority Data
Apr. 1, 2005 (JP) 2005-105946
Apr. 1, 2005 (JP) 2005-105947

(51) Int. Cl. G03B 21/28; G03B 21/14

(52) U.S. Cl. 353/97; 353/99

(57) ABSTRACT

A projection type of image displaying apparatus, comprising: a projection optical system for projecting an image light from an image forming element on a screen, the projection optical system having at least three curved mirrors; and a variable aperture mechanism disposed between a first curved mirror from the image forming element and a second curved mirror in the projection optical system, the variable mechanism entering and retreating a light shielding plate with respect to a projection light path to vary the light intensity of the image light.

This application is based on Japanese Patent Application Nos. 2005-105946, 2005-105947 the contents in which are incorporated herein by reference.

### BACKGROUND OF THE INVENTION

The present invention relates to a projection type of image displaying apparatus, i.e., rear-projection television and video projector provided with an image forming element such as liquid crystal element, DMD (digital micro mirror device) and so on.

As the projection type of image displaying apparatus, U.S. Pat. No. 6,648,476 B2 discloses a video projector in which an illumination optical system gives an illumination light to a DMD which in turn modulates the illumination light into an image light. The image light is projected through a projection optical system on a screen. In this apparatus, a variable aperture mechanism is positioned in the illumination optical system to adjust a diameter of effective light flux so that the brightness of the projection image can be reduced and the contrast can be increased, making it easy to view the projection image in a dark environment.

U.S. Patent Application Publication No. 2005/0001997 A1 also discloses a rear-projection television in which an illumination optical system illuminates an illumination light to a DMD which in turn modulates the illumination light into an image light. The image light is focused through a projection optical system on the rear surface of a screen. In this apparatus, an aperture adjusting mechanism is positioned in the illumination optical system to adjust a diameter of effective light flux every frame in response to the luminance level of the image so that the image can be displayed suitably to viewing in response to the image scene.

In the above conventional projection type of image displaying apparatuses, as the illumination and projection optical systems comprise a refraction optical system and have a straight optical path, the position of the variable aperture mechanism is free to a certain extent. Also, mounting and dismounting the variable aperture mechanism can be conducted freely to a certain extent.

On the other hand, in the projection type of image displaying apparatus provided with a projection optical system comprising a reflection optical system having reflection mirrors, the projection optical system has bent optical paths. Even if the variable aperture mechanism is positioned in a bent optical path, the light shielding plate or actuator thereof interferes with a constitution component in the adjacent optical path, making it difficult to mount and dismount the variable aperture mechanism. Thus, in the projection type of image displaying apparatus provided with the projection optical system comprising the reflection optical system, there has been a disadvantage that very hard restrictions are placed on a space for positioning the variable aperture mechanism. Also, the variable aperture mechanism could not be assembled, adjusted and inspected alone. Because of difficulty of maintenance and replacement, the variable aperture mechanism which is exposed to a projection light to generate heat has been necessary to be made of heat resistant material.

In the projection type of image displaying apparatus in which an entering position of the light shielding plate of the variable aperture mechanism into an optical path (an opening area of the variable aperture) can be changed in plural steps, it is necessary to precisely linearly detect the positions of the light shielding plate with few sensors.

### SUMMARY OF THE INVENTION

It is an object of the present invention to provide a projection type of image displaying apparatus comprising a variable aperture mechanism disposed at a proper position and having a compact construction.

It is an another object of the present invention to provide a projection type of image displaying apparatus in which a position of light shielding plate of the variable aperture mechanism can be accurately linearly detected at a low cost by means of a few sensor.

It is a still another object of the present invention to provide a projection type of image displaying apparatus in which a variable aperture mechanism can be mounted and dismounted, and also assembled, adjusted and inspected alone, and a replacement work can be easily conducted at the failure.

In the first aspect of the present invention to accomplish the above objects, there is provided a projection type of image displaying apparatus, comprising:

a projection optical system for projecting an image light from an image forming element on a screen, the projection optical system having at least three curved mirrors; and

a variable aperture mechanism disposed between a first curved mirror and a second curved mirror from the image forming element side in the projection optical system, the variable mechanism entering and retreating a light shielding plate with respect to a projection light path to vary the light intensity of the image light.

In the second aspect of the present invention to accomplish the above objects, there is provided a projection type of image displaying apparatus, comprising:

a projection optical system for projecting an image light from an image forming element on a screen, the projection optical system having at least three curved mirrors; and

a variable mechanism for entering and retreating a light shielding plate with respect to a projection light path to vary the light intensity of the image light, the light shielding plate being entered from a space between a light flux entering any one of the at least three curved mirrors and a light flux reflecting on the curved mirror concerned or a lateral space of a plane formed by a reference axis entering any one of the at least three curved mirrors and a reference axis reflecting on the curved mirror concerned.

In the third aspect of the present invention to accomplish the above objects, there is provided a projection type of image displaying apparatus, comprising:

a projection optical unit, the projection optical unit comprising a projection optical system for projecting an image light from an image forming element on a screen, the projection optical system having at least two curved mirrors; and

a variable aperture mechanism, the variable aperture mechanism being mounted and dismounted in a direction substantially perpendicular to a reference plane formed by a projection reference axis between the curved mirrors disposed on the screen side and the opposite side of the variable aperture mechanism and a projection reference axis to the curved mirror disposed on the opposite side to the screen side of the variable aperture mechanism.

In the fourth aspect of the present invention to accomplish the above objects, there is provided a projection type of image displaying apparatus, comprising:

a projection optical unit, the projection optical unit comprising a projection optical system for projecting an image light from an image forming element on a screen, the projection optical system having at least two curved mirrors; and

a variable aperture mechanism, the variable aperture mechanism being mounted and dismounted in a direction substantially perpendicular to a reference plane formed by a projection reference axis between the curved mirrors disposed on the screen side and the opposite side of the variable aperture mechanism and a projection reference axis from the curved mirror disposed on the screen side of the variable aperture mechanism.

In the fifth aspect of the present invention to accomplish the above objects, there is provided a projection type of image displaying apparatus, comprising:

a projection optical system for projecting an image light from an image forming element on a screen, the projection optical system including at least two curved mirrors;

an aperture unit, the aperture unit including a variable aperture mechanism disposed between the two curved mirrors and attachment seats; and

a holding member for surrounding and holding the projection optical system, the holding member including attachment surfaces on which the attachment seats of the aperture unit are attached, the attachment surface being parallel to a reference plane formed by any two reference axes of a projection reference axis between the two curved mirrors, a projection reference axis from the curved mirror disposed at the screen side of the variable aperture mechanism, and a projection reference axis to the curved mirror disposed at the opposite side to the screen side of the variable aperture mechanism;

wherein the attachment seats of the aperture unit can be mounted and dismounted with respect to the attachment surfaces of the holding member.

In the above aspects of the present invention, the image forming element may include a transparent liquid crystal display element (LCD), a reflective liquid crystal display element (LCOS) and DMD. The projection optical system having at least three curved mirrors may have an optical path progressing upward or downward, otherwise leftward or rightward as the optical path is bent when the image displaying apparatus is set in a normal state.

### BRIEF DESCRIPTION OF THE DRAWINGS

Further objects and advantages of the present invention will become clear from the following description taken in conjunction with the preferred embodiments thereof with reference to the accompanying drawings, in which:

FIG. 1 is a schematic side elevational view of a rear-projection television as an embodiment of a projection type of image displaying apparatus according to the present invention;

FIG. 2 is a perspective view of an internal construction member of the rear-projection television of FIG. 1;

FIG. 3 is a partly fragmental perspective view of an illumination optical system of the rear-projection television of FIG. 1;

FIG. 4 is a sectional view of a projection optical system of the rear-projection television of FIG. 1;

FIG. 5A is a front view of the variable aperture mechanism;

FIG. 5B is a partly enlarged view of Fig. A;

FIG. 6 is a schematic view showing relations of rotation angles of the light shielding plate and aperture values;

FIG. 7 is a perspective view of a case body of the illumination optical system and a lower holding member of the projection optical system showing an attachment hole and an attachment surface of the aperture unit;

FIG. 8 is a side view of the case body of the illumination optical system and the lower holding member of the projection optical system showing an attached state of the aperture unit;

FIG. 9 is a schematic sectional view of the projection optical system showing an another attached state of the aperture unit; and

FIG. 10 is a control block diagram of the projection type of image displaying apparatus.

### DETAILED DESCRIPTION OF THE PREFERRED EMBODIMENTS

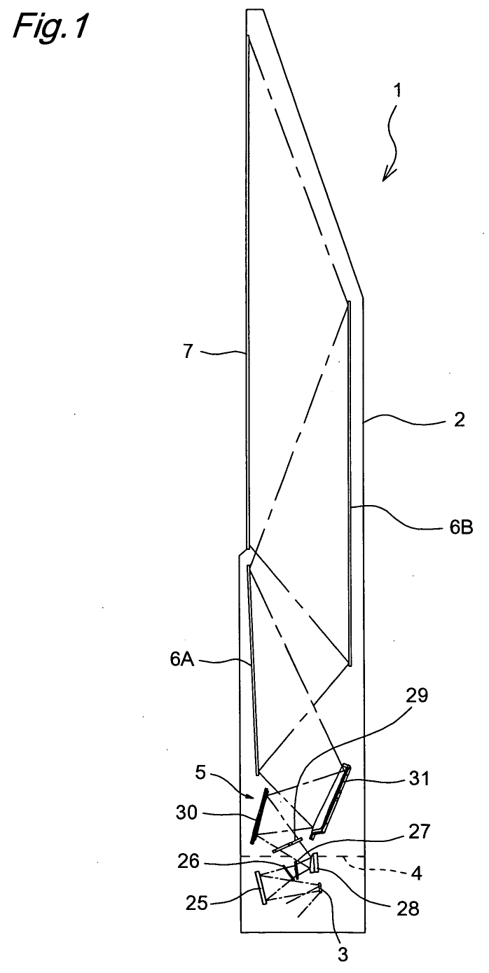

FIG. 1 shows a rear-projection television 1 (rear-pro TV) as an embodiment of a projection type of image displaying apparatus according to the present invention. In a casing 2 of the rear-pro TV 1 are housed a digital micro mirror device (DMD) 3 as one example of the projection type of image forming element, an illumination optical system 4 for irradiating the DMD 3 with an illumination light, the system being disposed in a substantially horizontal direction, and a projection optical system 5 for enlarging a projection light, i.e., image reflected on the DMD 3, the system being disposed in a substantially vertical direction. On the upper portion of the front surface of the casing 2 is provided a screen 7 on which the image enlarged by the projection optical system 5 is projected through two plane mirrors 6A, 6B.

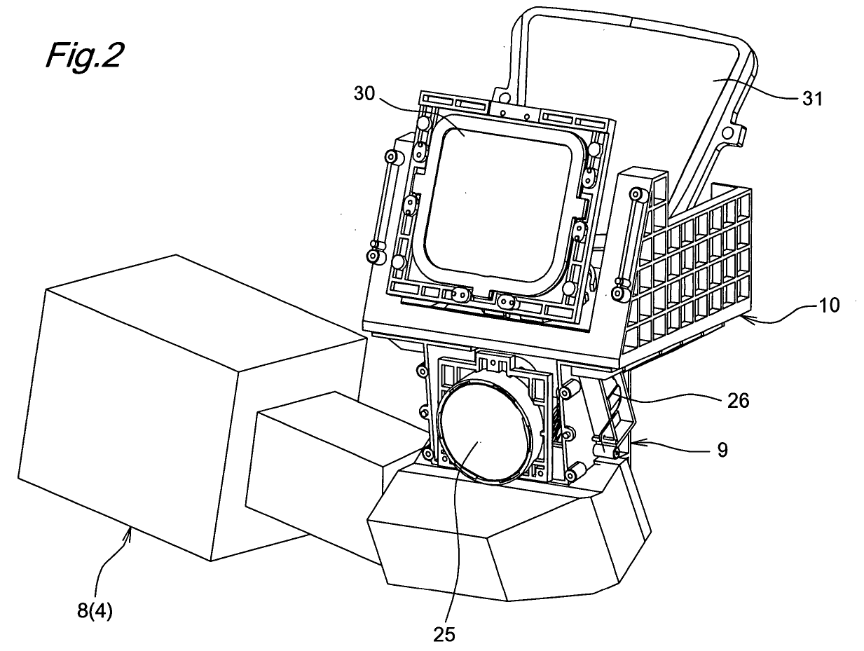

Referring to FIG. 1 in conjunction with FIG. 2, in the lower portion of the casing 2 are housed a lower side optical element holding member 9 and an upper side optical element holding member 10 as well as a case body 8 in which the illumination optical system 4 is housed. By means of these lower side and upper side optical element holding members 9, 10, optical elements of the DMD 3 and the projection optical system 5 are held.

The DMD 3 has a mirror surface comprising a number of micro mirror elements arranged two-dimensionally. The reflection angle of each mirror element can be switched in two directions independently from each other. Each micro mirror element corresponds to a pixel of the image projected on the screen 7. The mirror element with the reflection angle set in a direction of two directions is “ON” state. The light flux from the illumination optical system 4 reflected on the mirror elements of “ON” state is projected on the screen 7 through the projection optical system 5 and the plane mirrors 6A, 6B. On the other hand, the mirror element with the reflection angle set in the other direction of two directions is “OFF” state. The light flux from the illumination optical system 4 reflected on the mirror elements of “OFF” state does not enter the projection optical system 5 and is displayed on the screen 7 as black pixels.

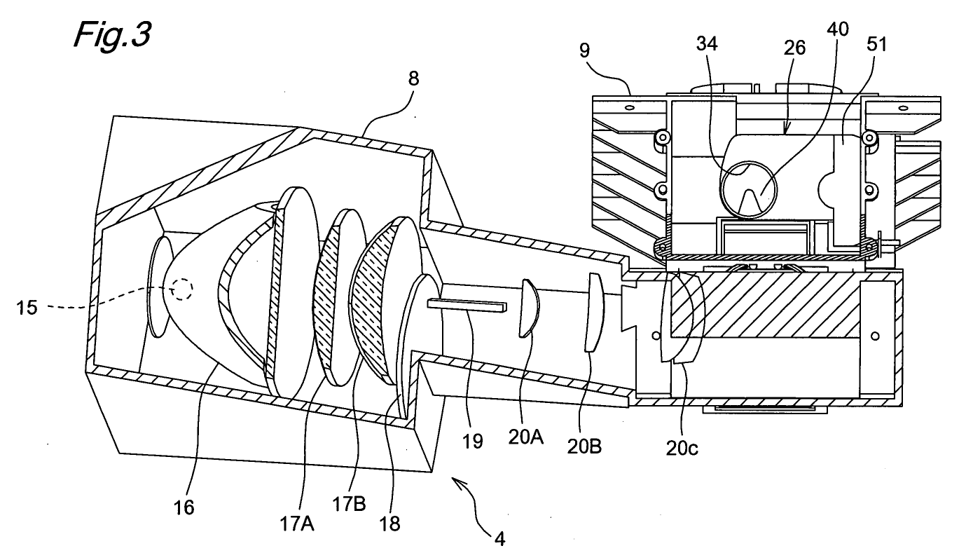

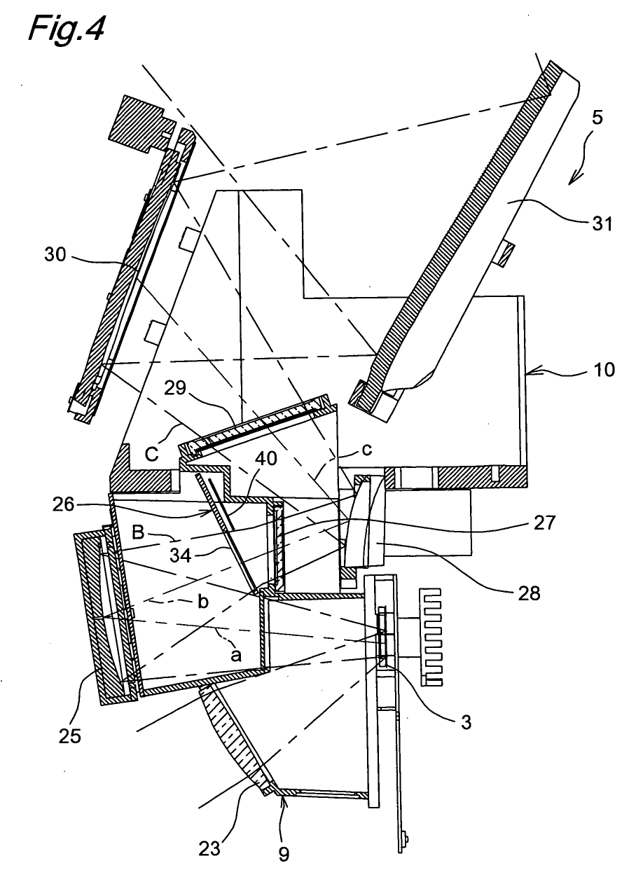

Referring to FIG. 3, the illumination optical system 4 is provided in a direction substantially perpendicular to the projection optical system 5. The system comprises a discharge lamp 15 comprising, for example, an extra high pressure mercury lamp, a parabolic mirror 16, condenser lenses 17A, 17B, a color wheel 18, an integrator rod 19, relay lenses 20a, 20 B, 20C, an aperture and mirror not shown and an entrance lens 23 shown in FIG. 4.

The light discharged from the discharge lamp 15 is converted by the parabolic mirror 16 into a collimated light and converged on the incidence plane of the integrator rod 19 through the condenser lenses 17A, 17B. On the circumference of the color wheel 18 disposed in the vicinity of the incidence plane of the integrator rod 19, color filters each of which transmits a color light of red, blue and green respectively are disposed so that the incident light into the integrator rod 19 is color separated in a time-sharing manner as the color wheel 18 rotates. The integrator rod 19 comprises a rectangular glass rod, on the inner surface of which the incident light is total reflected and overlapped to emit a light flux having a uniform intensity distribution from the exit surface. The integrator rod 19 may be a hollow rod having incident surfaces inside. The image on the exit surface of the integrator rod 19 is propagated to the DMD 3 through the relay lenses 20a, 20B, 20C, the aperture and mirror not shown and the entrance lens 23 shown in FIG. 4. Thus, the DMD 3 is illuminated with a uniform light intensity.

Referring to FIG. 1 and FIG. 4, the projection optical system 5 comprises four curved mirrors 25, 28, 30, 31, two aberration correction plates 27, 29 and a variable aperture mechanism 26. Specifically, starting from the DMD 3, there are disposed the concave mirror 25 having a spherical surface, the variable aperture mechanism 26, the first aberration correction plate 27, the convex mirror 28 having an aspheric surface of rotational symmetry, the second aberration correction plate 29, the first free-form mirror 30 and the second free-form mirror 31. Among the optical elements which the projection optical system 5 is provided with, the concave mirror 25, the variable aperture mechanism 26, the first aberration correction plate 27 and the convex mirror 28 are held by the lower optical element holding member 9 while the first free-form mirror 30 and the second free-form mirror 31 are held by the upper optical element holding member 10.

The concave mirror 25 is arranged opposite to the DMD 3 and the convex mirror 28 is arranged opposite to and slightly above the concave mirror 25. Similarly, the first free-form mirror 30 is arranged opposite to and slightly above the convex mirror 28 and the second free-form mirror 31 is arranged opposite to and slightly above the first free-form mirror 30. Thus, the light flux from the DMD 3 is reflected on the concave mirror 25, the convex mirror 28, the first free-form mirror 30 and the second free-form mirror 31 and directed upward as the optical path is bent and projected on the first plane mirror 6A.

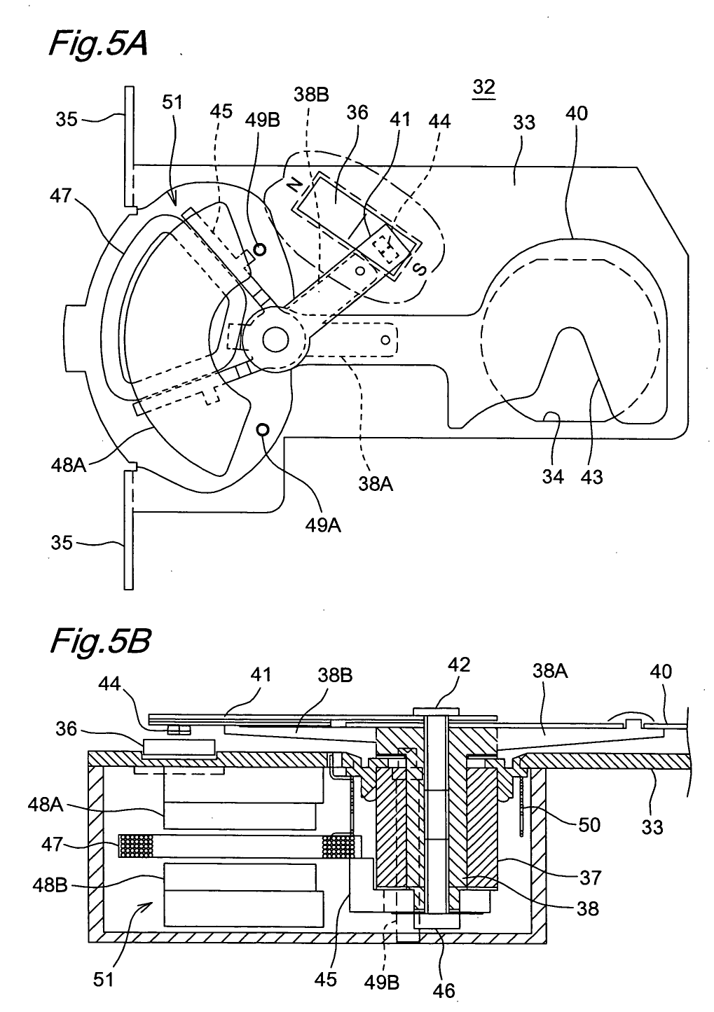

FIG. 5 shows an aperture unit 32 in which the variable aperture mechanism 26 is incorporated. The base of the aperture unit 32 comprises a rectangular plate of metal (SUS) on one side of which is formed a fixed aperture 34 and on the other side of which are extended two attachment seats 35. In the middle of the base 33, a magnet 36 is attached. On the base 33A is fixed a bearing 37 into which a rotation shaft 38 is inserted. On the one end of the rotation shaft 38, two arms 38A, 38B are extended parallel to the base 33. On one arm 38A is mounted a light shielding plate 40 of metal (aluminum) while on the other arm 38B is mounted a sensor supporting plate 41. The light shielding plate 40 and the sensor supporting plate 41 are fixed on the rotation shaft 38 by means of screw 42. The extremity of the light shielding plate 41 is extended to the fixed aperture 34 of the base 33. On the part opposite to the fixed aperture 34 is formed a V-shaped cutout 43. On the extremity of the sensor supporting plate 41, a hall element 44 is attached so as to oppose the magnet 36 of the base 33. When the light shielding plate 40 pivots to move the hall element 44, the hall element 44 outputs a voltage corresponding to a magnetic flux density of the magnet 36 at the moved position. As the hall element 44 is parallel to the pivot surface of the light shielding plate 40, i.e., the moving direction of the hall element 44, the output voltage of the hall element 44 varies linearly to the change of the position of the hall element 44, i.e., the rotational angle of the light shielding plate 40. If a table showing relations between output voltages of the hall element 44 and positions of the hall element 44, i.e., rotational angles of the light shielding plate 40 is previously stored, a position of the hall element 44, i.e., a rotational angle of the light shielding plate 40 can be known from an output voltage of the hall element 44.

On the other end of the rotation shaft 38, a V-shaped coil support frame 45 is attached and fixed by means of screw 46. On the coil support frame 45, a coil 47 wound in a sector is supported by means of adhesive. A pair of magnets 48A, 48B is attached on the base 33 so that the coil 47 is sandwiched. On the base are attached stoppers 49A, 49B which come into contact with the coil support frame 45 to restrict the pivot range of the light shielding plate 40. Around the bearing 37 is provided a torsion spring 50 one end of which engages with the base 33 and the other end of which engages with the coil support frame 45. The torsion spring 50 urges the rotation shaft 38 in a direction that the light shielding plate 40 retreats entirely from the fixed aperture 34 to completely open the fixed aperture 34. The coil support frame 45, coil 47 and the pair of magnets 48A, 48B constitute an actuator for driving the light shielding plate 40.

When applying the electric current to the coil 47, a force is caused in the coil 47 in accordance with Fleming's right-hand rule, resulting in rotation of the light shielding plate 40 around the rotation shaft 38. Specifically, a periodic rectangular constant voltage signal is applied to the coil 47. The rotation speed is controlled by changing the duty ratio of the rectangular signal. Also, the rotational direction can be varied by reversing the positive and negative rectangular signals. The applied signal is varied based on information of the variation of the rotational angle from the hall element 40 to control the position of the light shielding plate 40.

The variable aperture mechanism 26 in this embodiment does not have a mechanical construction such as link mechanism as in the case of iris diaphragm and is driven by an electromagnetic power. Thus, the mechanism 26 has a high durability and can move the light shielding plate at a high speed.

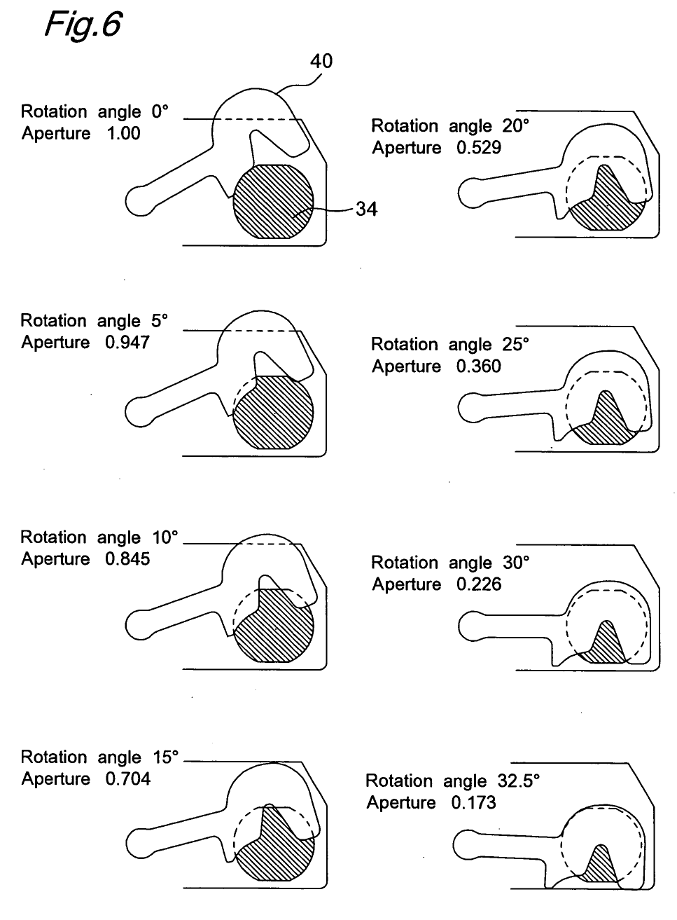

The pivot range, i.e., rotational angle of the light shielding plate 40 is 32.5°. When the light shielding plate 40 pivots from 0° to 32.5° as shown in FIG. 6, the fixed aperture 34 is intercepted so that a ratio of the opening area except a portion intercepted by the light shielding plate 40 to the area of the fixed aperture 34, that is to say, an aperture ratio can be substantially linearly changed from 1 to 0.173. When the rotational angle is 0°, the shielding plate 40 is retreated from the projection optical path so as not to intercept the projection light (corresponding to the retreat position described above).

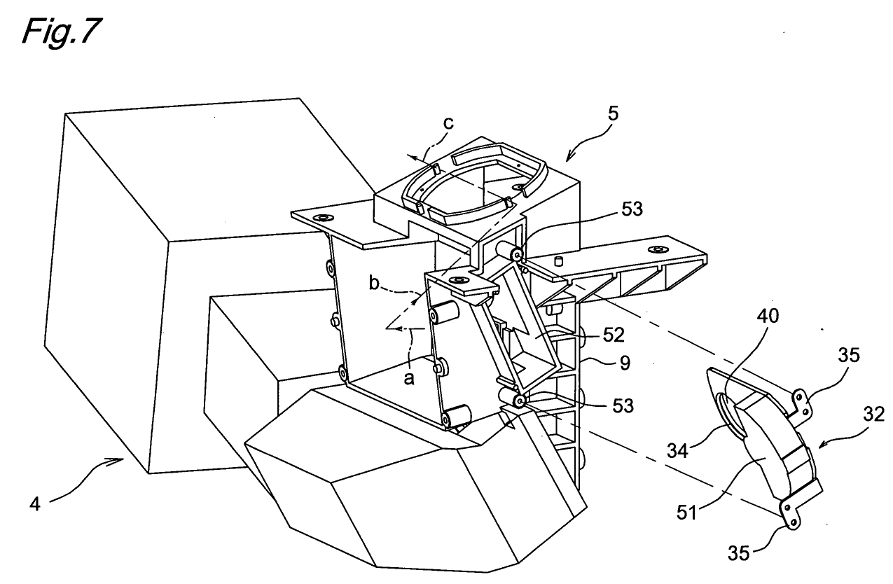

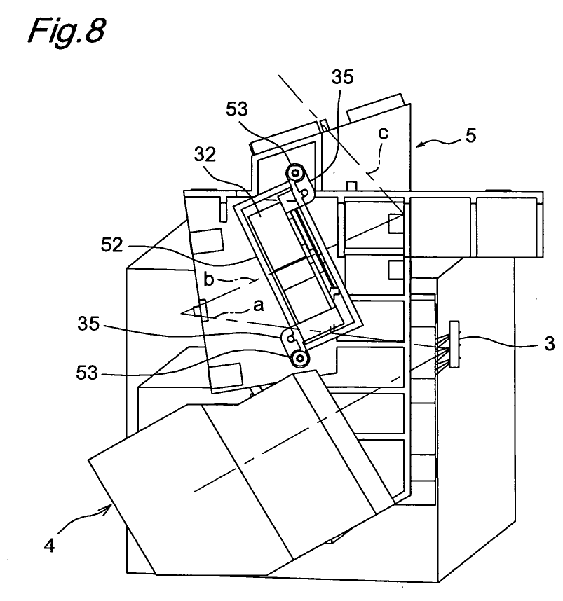

FIG. 7 shows a construction for mounting the aperture unit 32 on the predetermined position. In the side surface of the lower optical element holding member 9 is formed a rectangular attachment hole 52 for inserting and attaching the aperture unit 32. The attachment hole 52 is opened in a direction substantially perpendicular to a plane (hereinafter, referred to as reference axis plane) that is formed by any two projection reference axes of a projection reference axis “b” between the first concave mirror 25 and the second convex mirror 28 which are disposed on DMD side and the screen side of the variable aperture mechanism 26 respectively, an incidence projection reference axis “a” to the first concave mirror 25, and an exit projection reference axis “c” from the second convex mirror 28. That is to say, the reference axis plane may be any one of a plane formed by the incidence projection reference axis “a” and the projection reference axis “b”, a plane formed by the projection reference axis “b” and the exit projection reference axis “c”, and a plane formed by the incidence projection reference axis “a” and the exit projection reference axis “c”. Here, the projection reference axes “a”, “b” and “c” are straight lines connecting the center of the DMD 3 and the center of the entrance pupil of the projection optical system 5 or the pupil surface (conjugated plane with the light source; in this embodiment, the light source 15, the incidence surface of the integrator rod 19, the pupil surface of the illumination optical system 4, and the pupil surface of the projection optical system 5 has a conjugated relation) of the projection optical system 5 and are reference axes of the projection optical system 5, as it were, correspond to central axes of the projection optical path. The reference axes of the projection optical system 5 are on the same plane. On the diagonal corner edges of the attachment hole 52, two cylindrical attachment surfaces 53 are provided. The two attachment surfaces 53 are parallel to the reference axis plane. Thus, the aperture unit 32 can be inserted into the projection optical path between the first concave mirror 25 and the second convex mirror 28 in a direction perpendicular to the reference axis plane and opposite to the illumination optical system 4. Then, the two attachment seat 35 are mounted on the attachment surfaces 53 and fixed by means of screw not shown.

In the above direction substantially perpendicular to the reference axis plane, there is a broader space than a space between the optical paths folded by the concave mirror 25 and the convex mirror 28. As the aperture unit 32, i.e., the attachment hole 52 and the attachment surface 53 of the variable aperture mechanism 26 is provided in the direction of this relatively broader space, mounting and dismounting the variable aperture mechanism 26 can be easily conducted in the above attachment state.

Also, in the above attachment state, the aperture unit 32, i.e., the variable aperture mechanism 26 can be mounted and dismounted at the opposite side to the illumination optical system 4 with respect to the projection optical system 5. Therefore, the variable aperture mechanism 26 can be easily mounted and dismounted without interfering with the construction components of the illumination optical system 4.

As described above, since the aperture unit 32, i.e., the variable aperture mechanism 26 can be mounted and dismounted from the relatively broader space, the variable aperture mechanism 26 can be easily mounted and dismounted without interfering with the construction components of the illumination optical system 4 and the projection optical system 5. Thus, the variable aperture mechanism 26 can be assembled, adjusted and inspected alone. Also, at the failure, a replacement work of the variable aperture mechanism 26 can be easily conducted.

Further, as shown in FIG. 4, the light shielding plate 40 of the variable aperture mechanism 26 is positioned in the vicinity of the fixed aperture 34 and at the screen side of the fixed aperture 34. Thus, it is possible to prevent the light shielding plate 40 from generating heat due to the heat received from the light flux at the light source side of the fixed aperture 34 and affecting the movement. The light shielding plate 40 slants against the reflection surface of the DMD 3.

As the projection optical path between the first concave mirror 25 and the second convex mirror 28 has a relatively small diameter of light flux because the pupil position of the projection optical system 5 exists, there is a broader space around the flux. Therefore, in the above attachment state, the variable aperture mechanism 26 can be disposed at a proper position utilizing such broader space.

The actuator 51 of the aperture unit 32 is disposed in a lateral space to the reference axis plane (see FIG. 3). On the other hand, the retreat position of the light shielding plate 40 of the aperture unit 32 inserted into the projection optical path is situated in a space between a light flux B leaving the first concave mirror 25 for the second convex mirror 28 and a light flux C leaving the second convex mirror 28 for the third free-form mirror 30.

As both of the light flux B exiting from the image forming element, reflecting on the first concave mirror 25 and traveling to the second convex 28 and the light flux C reflecting on the second convex mirror 25 and traveling to the third free-form mirror 30 have still small diameters, a space between the light fluxes B, C and a lateral space of the reference axis plane formed by the reference axes b, c thereof are also broad. Therefore, the actuator 51 of the variable aperture mechanism 26 and the retreat position of the light shielding plate 40 can be disposed at a proper position utilizing such broader space.

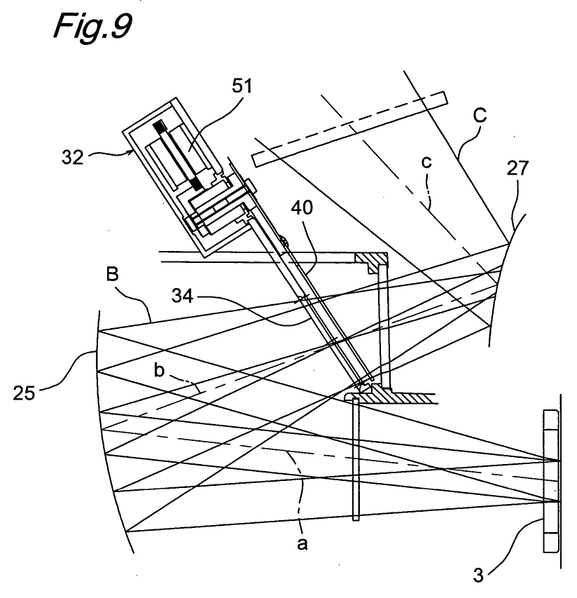

By contraries, as shown in FIG. 9, the actuator 51 of the aperture unit 32 may be positioned at a space between the light flux B leaving the first concave mirror 25 for the second convex mirror 28 and the light flux C leaving the second convex mirror 28 for the third free-form mirror 30 while the retreat position of the aperture unit 32 may be positioned at a lateral space of the light path plane.

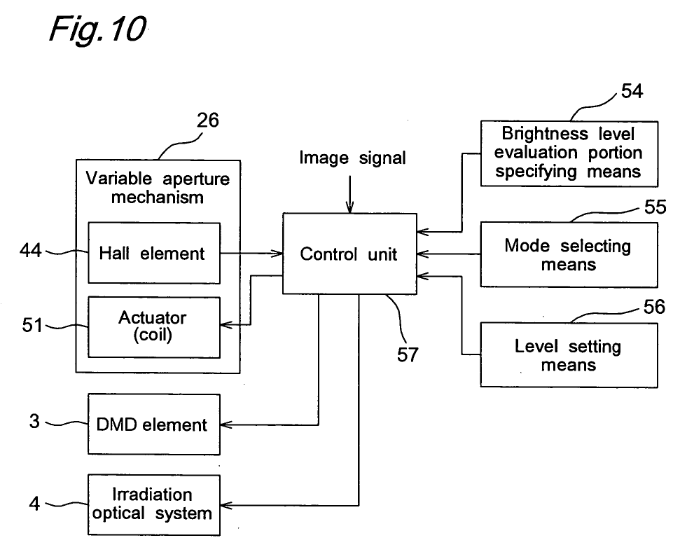

FIG. 10 shows a control block diagram of the projection type of image displaying apparatus. The projection type of image displaying apparatus comprises a brightness level evaluation portion specifying means 54, a mode selecting means 55, a level setting means 56 and a control unit 57 as well as the DMD 3, the illumination optical system 4, and the variable aperture mechanism 26 of the projection optical system 5. The brightness level evaluation portion specifying means 54 outputs an evaluation portion signal specified by a user that the evaluation of the brightness level of the image signal is focused on the center of the screen or obtained by taking the average of the whole screen. The mode selecting means 55 outputs a mode signal of image scene selected by a user, for example, movie mode, sports mode ands so on. The level setting means 56 outputs a level signal of variable aperture effect selected by a user, for example, 3 levels of large, middle and small. The control unit 57 drives the illumination optical system 4 and also controls the DMD 3 based on the image signal of such as video and television. Also, the control unit 57 drives the actuator 51 of the variable aperture mechanism 26 based on the image signal, mode signal from the mode selecting means 55, level signal from the level setting means 56, position detecting signal of the light shielding plate 40 from the hall element 44.

Then, operation of the projection type of the image displaying apparatus having above construction, especially operation of the variable aperture by the control unit will be described.

First, a brightness distribution of image signals of a frame is evaluated in accordance with the evaluation portion specified by the brightness level evaluation portion specifying means 54 to decide gain value and aperture value suitable to the selected mode and level by calculation. The actuator 51 is driven to pivot the light shielding plate 40 to an angle corresponding to the aperture value. Thus, the valid diameter of the light flux is adjusted by the shielding plate with respect to each frame to vary the quantity of the projection light. As to the image scene of high brightness level, the valid light flux is made larger to increase the quantity of light. As to the image scene of low brightness level, the valid light flux is made smaller to decrease the quantity of light and emphasize the dark portion. Especially, the smaller the valid light flux is made, the more the peripheral portion of the valid light flux is intercepted and the scattering of the light is decreased, enhancing the contrast of the screen. Looking at the displayed image, the user can change the evaluation portion by the brightness level evaluation portion specifying means 54 and also change the level of variable aperture effect by the level setting means 56 to set a desired image.

In the above embodiment, the variable aperture and the fixed aperture are provided in one aperture unit 32, though these may be separately provided. In this case, disposing the fixed aperture at the pupil position enables the difference of the matching of the pupil position to be minimized. Also, positioning the fixed aperture at a position shifted from the pupil position where the fixed aperture is disposed allows the variable aperture to be provided at a position such as the pupil position that there is little restriction, enabling to construct a compact apparatus.

In the above embodiment, the DMD 3 is employed as the image forming element, though the present invention is not limited to this, a transparent liquid crystal display element (LCD) and a reflective liquid crystal display element (LCOS) can be also employed.

The projection optical system 5 is not limited to the above embodiment but may have another optical system construction. For example, number of the curved mirrors, layout of the spherical, aspheric and free-form mirrors, or shape of each surface of the curved mirrors may be different.

The type of the variable aperture mechanism in the above embodiment in which the light shielding plate is directly attached on the actuator and moves to intercept the projection light to change the quantity of light is preferable because it is movable at a high speed and has high durability, though another aperture mechanism such as one having iris diaphragm may be employed in the case that it is not necessary to change the aperture at a high speed. In any variable aperture mechanism, the variable aperture mechanism is mounted and dismounted in a direction perpendicular to a plane (reference axis plane) in which the projection light is bent by mirrors, allowing easy mounting and dismounting.

The present invention is not only applied to the rear-projection television but also applied to a video projector.

Although the present invention has been fully described by way of the examples with reference to the accompanying drawing, it is to be noted that various changes and modifications will be apparent to those skilled in the art. Therefore, unless such changes and modifications otherwise depart from the spirit and scope of the present invention, they should be construed as being included therein.

What is claimed is:

1. A projection type of image displaying apparatus, comprising:
a projection optical system for projecting an image light from an image forming element on a screen, the projection optical system having at least three curved mirrors; and
a variable aperture mechanism disposed between a first curved mirror and a second curved mirror from the image forming element side in the projection optical system, the variable mechanism entering and retreating a light shielding plate with respect to a projection light path to vary the light intensity of the image light.

2. The projection type of image displaying apparatus as in claim 1, wherein:
an actuator for driving the light shielding plate is disposed in a space between a light flux leaving the first curved mirror for the second curved mirror and a light flux leaving the second curved mirror for the third curved mirror, and
the retreat position of the light shielding plate is situated in a lateral space of a plane formed by a projection reference axis from the first curved mirror to the second curved mirror and a projection reference axis from the second curved mirror to the third curved mirror.

3. The projection type of image displaying apparatus as in claim 1, wherein:
an actuator for driving the light shielding plate is disposed in a lateral space of a plane formed by a projection reference axis from the first curved mirror to the second curved mirror and a projection reference axis from the second curved mirror to the third curved mirror, and
the retreat position of the light shielding plate is situated in a space between a light flux leaving the first curved mirror for the second curved mirror and a light flux leaving the second curved mirror for the third curved mirror.

4. The projection type of image displaying apparatus as in claim 1, further comprising a fixed aperture disposed in a pupil position of the projection optical system, wherein the light shielding plate is positioned in the vicinity of the fixed aperture at the screen side of the fixed aperture.

5. The projection type of image displaying apparatus as in claim 4, wherein the variable aperture mechanism and fixed aperture are incorporated in one aperture unit.

6. The projection type of image displaying apparatus as in claim 1, wherein the light shielding plate is slanted against the surface of the image forming element.

7. The projection type of image displaying apparatus as in claim 1, further comprising a position sensor for detecting a position of the light shielding plate of the variable aperture mechanism, the position sensor comprising a magnet disposed parallel to the movable surface of the light shielding plate and a magnetic field detecting element for detecting a magnetic flux density of the magnet at the position of the light shielding plate.

8. The projection type of image displaying apparatus as in claim 1, wherein the variable aperture mechanism has a spring for urging the light shielding plate to an aperture opened position.

9. The projection type of image displaying apparatus as in claim 1, wherein the projection optical system comprises four curved mirrors.

10. The projection type of image displaying apparatus as in claim 9, wherein the projection optical system further comprises an aberration correction plate between the second curved mirror and the third curved mirror.

11. A projection type of image displaying apparatus, comprising:
a projection optical system for projecting an image light from an image forming element on a screen, the projection optical system having at least three curved mirrors; and
a variable mechanism for entering and retreating a light shielding plate with respect to a projection light path to vary the light intensity of the image light, the light shielding plate being entered from a space between a light flux entering any one of the at least three curved mirrors and a light flux reflecting on the curved mirror concerned or a lateral space of a plane formed by a reference axis entering any one of the at least three curved mirrors and a reference axis reflecting on the curved mirror concerned.

12. The projection type of image displaying apparatus as in claim 11, further comprising a fixed aperture disposed in a pupil position of the projection optical system, wherein the light shielding plate is positioned in the vicinity of the fixed aperture at the screen side of the fixed aperture.

13. The projection type of image displaying apparatus as in claim 12, wherein the variable aperture mechanism and fixed aperture are incorporated in one aperture unit.

14. The projection type of image displaying apparatus as in claim 11, wherein the light shielding plate is slanted against the surface of the image forming element.

15. The projection type of image displaying apparatus as in claim 11, further comprising a position sensor for detecting a position of the light shielding plate of the variable aperture mechanism, the position sensor comprising a magnet disposed parallel to the movable surface of the light shielding plate and a magnetic field detecting element for detecting a magnetic flux density of the magnet at the position of the light shielding plate.

16. The projection type of image displaying apparatus as in claim 11, wherein the variable aperture mechanism has a spring for urging the light shielding plate to an aperture opened position.

17. The projection type of image displaying apparatus as in claim 11, wherein the projection optical system comprises four curved mirrors.

18. The projection type of image displaying apparatus as in claim 17, wherein the projection optical system further comprises an aberration correction plate between the second curved mirror and the third curved mirror.

19. A projection type of image displaying apparatus, comprising:
a projection optical unit, the projection optical unit comprising a projection optical system for projecting an image light from an image forming element on a screen, the projection optical system having at least two curved mirrors; and
a variable aperture mechanism, the variable aperture mechanism being mounted and dismounted in a direction substantially perpendicular to a reference plane formed by a projection reference axis between the curved mirror disposed on the screen side of the variable aperture mechanism and the curved mirror disposed on the opposite side to the screen side of the variable aperture mechanism and a projection reference axis to the curved mirror disposed on the opposite side to the screen side of the variable aperture mechanism.

20. The projection type of image displaying apparatus as in claim 19, further comprising an illumination optical system for irradiating the image forming element with a light from a light source, the illumination optical system being disposed in a direction substantially perpendicular to the reference plane with respect to the projection optical system, wherein the variable aperture mechanism can be mounted and dismounted at the opposite side to the illumination optical system.

21. The projection type of image displaying apparatus as in claim 19, wherein the projection optical system has four curved mirrors, and the variable aperture mechanism is disposed between the first curved mirror and the second curved mirror from the image forming element side.

22. A projection type of image displaying apparatus, comprising:
a projection optical unit, the projection optical unit comprising a projection optical system for projecting an image light from an image forming element on a screen, the projection optical system having at least two curved mirrors; and
a variable aperture mechanism, the variable aperture mechanism being mounted and dismounted in a direction substantially perpendicular to a reference plane formed by a projection reference axis between the curved mirror disposed on the screen side of the variable aperture mechanism and the curved mirror disposed on the opposite side to the screen side of the variable aperture mechanism and a projection reference axis from the curved mirror disposed on the screen side of the variable aperture mechanism.

23. The projection type of image displaying apparatus as in claim 22, further comprising an illumination optical system for irradiating the image forming element with a light from a light source, the illumination optical system being disposed in a direction substantially perpendicular to the reference plane with respect to the projection optical system, wherein the variable aperture mechanism can be mounted and dismounted at the opposite side to the illumination optical system.

24. The projection type of image displaying apparatus as in claim 22, wherein the projection optical system has four curved mirrors, and the variable aperture mechanism is disposed between the first curved mirror and the second curved mirror from the image forming element side.

25. A projection type of image displaying apparatus, comprising:
a projection optical system for projecting an image light from an image forming element on a screen, the projection optical system including at least two curved mirrors;
an aperture unit, the aperture unit including a variable aperture mechanism disposed between the two curved mirrors and attachment seats; and
a holding member for surrounding and holding the projection optical system, the holding member including attachment surfaces on which the attachment seats of the aperture unit are attached, the attachment surface being parallel to a reference plane formed by any two reference axes of a projection reference axis between the two curved mirrors, a projection reference axis from the curved mirror disposed at the screen side of the variable aperture mechanism, and a projection reference axis to the curved mirror disposed at the opposite side to the screen side of the variable aperture mechanism;
wherein the attachment seats of the aperture unit can be mounted and dismounted with respect to the attachment surfaces of the holding member.

26. The projection type of image displaying apparatus as in claim 25, wherein the image forming element is attached on the holding member.

27. The projection type of image displaying apparatus as in claim 25, further comprising:
an illumination unit, the illumination unit including an illumination optical system for irradiating the image forming element with a light from a light source, the illumination optical system being disposed in a direction substantially perpendicular to the reference plane; and
a case body for holding the illumination optical system, the case body being fixed on the holding member.

28. The projection type of image displaying apparatus as in claim 25, wherein the attachment surface of the holding member is positioned at the opposite side of the illumination unit.
